(19) United States
(12) Patent Application Publication
(10) Pub. No.: US 2019/0183039 A1
(43) Pub. Date: Jun. 20, 2019

(54) ZERO-TURN VEHICLE HAVING A ROTATABLE ENGINE GUARD

(71) Applicant: Schiller Grounds Care, Inc., Southampton, PA (US)

(72) Inventors: Jonathan Lapp, Johnson Creek, WI (US); Jeff Zur, Southampton, PA (US); Jameson Kronser, Oregon, WI (US)

(21) Appl. No.: 15/841,893

(22) Filed: Dec. 14, 2017

(51) Int. Cl. A01D 34/00; F02B 77/08

(52) U.S. Cl. CPC A01D 34/001; A01D 2101/00; F02B 77/08

(57) ABSTRACT

A zero-turn vehicle is provided. The zero-turn vehicle includes a frame, an engine supported on the frame and configured to output rotational power, two or more driving wheels rotatably mounted to an underside of the frame, and a guard having a first end and a second end. The first end of the guard is fixedly secured to the frame by a hinge mechanism, and the second end of the guard is configured to engage the frame by a latching mechanism. In a first position, the second end of the guard is engaged with the frame by the latching mechanism, such that the engine is covered by the guard. In a second position, the second end of the guard is disengaged from the frame by the latching mechanism, such that the guard is rotatable about the hinge mechanism so as to expose the engine from the guard.

### BACKGROUND OF THE INVENTION

The present invention relates to a zero-turn (“ZT”) vehicle, particularly a ZT lawnmower, having a rotatable or pivoting engine guard or shroud system.

A ZT vehicle typically includes a frame and three or four wheels, such as one or two swiveling wheels mounted toward a front of the frame and two relatively large driving wheels at a rear of the frame. The driving wheels rotate independently of each other based on input from an operator. The operator can control the rotational speeds of the driving wheels via control levers, each associated with a respective driving wheel.

In conventional landscape machinery, such as ZT vehicles and particularly ZT lawnmowers, the engine is typically covered and protected by a shroud or guard for the safety of the operator. In particular, the engine guard prevents users or environmental components from coming into contact with the engine, as these could cause damage to the engine. The guard or shroud also prevents a user from easily accessing the engine, thereby reducing the risk of the user being harmed by the engine or of the engine causing damage to environment.

In some conventional lawnmowers, the engine guard is attached by fasteners to the lawnmower frame, such that tools are required to remove the engine guard. Such conventional engine guards are problematic because tools are not always available in the field. The engine guard may also be damaged or displaced when removed from the lawnmower. In other conventional lawnmowers, only a portion of the engine guard needs to be removed or moved in order to allow a user to access a portion of the engine, with or without the use of tools. However, such conventional engine guards can be problematic because they do not allow access to the entire engine, for example, for servicing of the engine.

Accordingly, it would be desirable to provide a ZT vehicle, and particularly a ZT lawnmower, which does not require tools for movement or removal of the engine guard, thereby providing a user easy access to the entire engine while also keeping the engine secured against damage from outside influences.

### BRIEF SUMMARY OF THE INVENTION

In one embodiment, the present invention is directed to a zero-turn (“ZT”) vehicle comprising a frame, an engine supported on the frame and configured to output rotational power, two or more driving wheels rotatably mounted to an underside of the frame, and a guard having a first end and a second end. The first end of the guard is fixedly secured to the frame by a hinge mechanism, and the second end of the guard is configured to engage the frame by a latching mechanism. In a first position, the second end of the guard is engaged with the frame by the latching mechanism, such that the engine is covered by the guard. In a second position, the second end of the guard is disengaged from the frame by the latching mechanism, such that the guard is rotatable about the hinge mechanism so as to expose the engine from the guard.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there is shown in the drawings an embodiment which is presently preferred. It should be understood, however, that the invention is not limited to the precise arrangements and instrumentalities shown.

In the drawings:

FIG. 1 is a rear and right side perspective view of a rotatable engine guard according to an embodiment of the present invention;

FIG. 2 is a front elevational view of the rotatable engine guard of FIG. 1;

FIG. 3 is a left side elevational view of the rotatable engine guard of FIG. 1;

FIG. 4 is a right side elevational view of the rotatable engine guard of FIG. 1;

FIG. 5 is a top plan view of the rotatable engine guard of FIG. 1;

FIG. 6 is a front and right side perspective view of a ZT lawnmower including the rotatable engine guard of FIG. 1;

FIG. 7 is a front and left side perspective view of the ZT lawnmower including the rotatable engine guard of FIG. 1; and

FIG. 8 is an enlarged front and right side perspective view of a ZT lawnmower including the rotatable engine guard of FIG. 1.

### DETAILED DESCRIPTION OF THE INVENTION

Reference will now be made in detail to an embodiment of the invention, examples of which are illustrated in the accompanying drawings. The terminology used in the description of the invention herein is for the purpose of describing the particular embodiment only and is not intended to be limiting of the invention.

As used in the description of the invention, the singular forms “a”, “an” and “the” are intended to include the plural forms as well, unless the context clearly indicates otherwise. The words “and/or” as used herein refers to and encompasses any and all possible combinations of one or more of the associated listed items. The words “comprises” and/or “comprising,” when used in this specification, specify the presence of the stated features, integers, operations, elements, and/or components, but do not preclude the presence of addition of one or more other features, integers, steps, operations, elements, components, and/or groups thereof

It should also be understood that the terms “about,” “approximately,” “generally,” “substantially” and like terms, used herein when referring to a dimension or characteristic of a component of the invention, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

The words “right,” left,” “lower,” “upper,” “front” and “rear” designate directions in the drawings to which reference is made. The words “inwardly” and “outwardly” refer to directions toward and away from, respectively, the geometric center of the guard, and designated parts thereof. The terminology includes the words noted above, derivatives thereof and words of similar import.

Although the words first, second, etc., are used herein to describe various elements, these elements should not be limited by these words. These words are only used to distinguish one element from another. For example, a first shaft could be termed a second shaft without departing from the scope of the present invention.

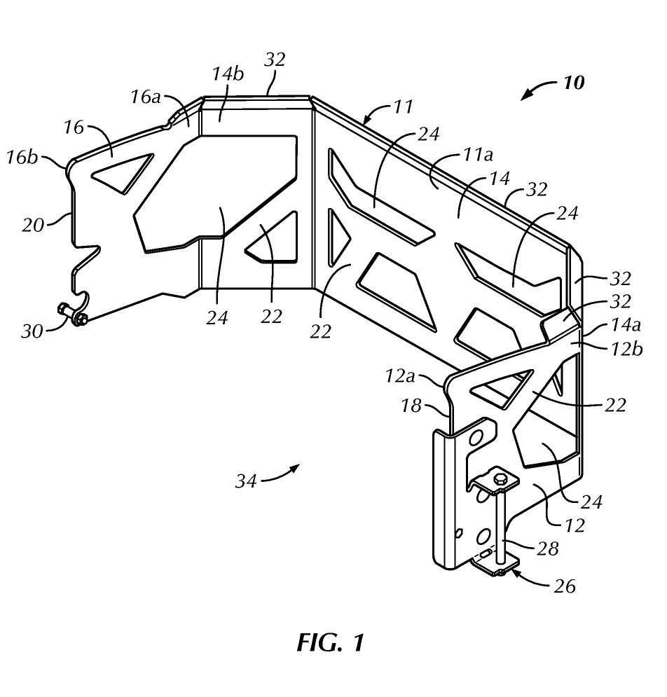

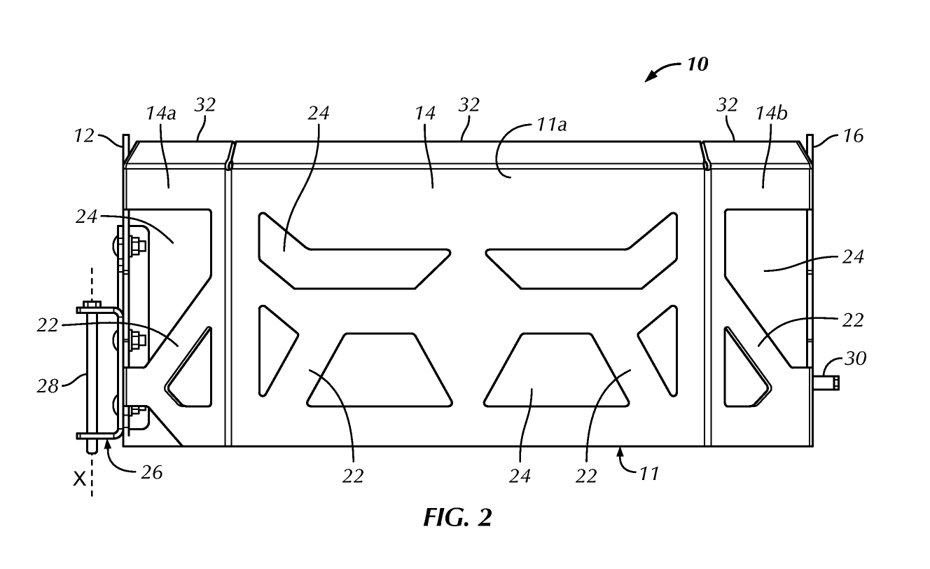

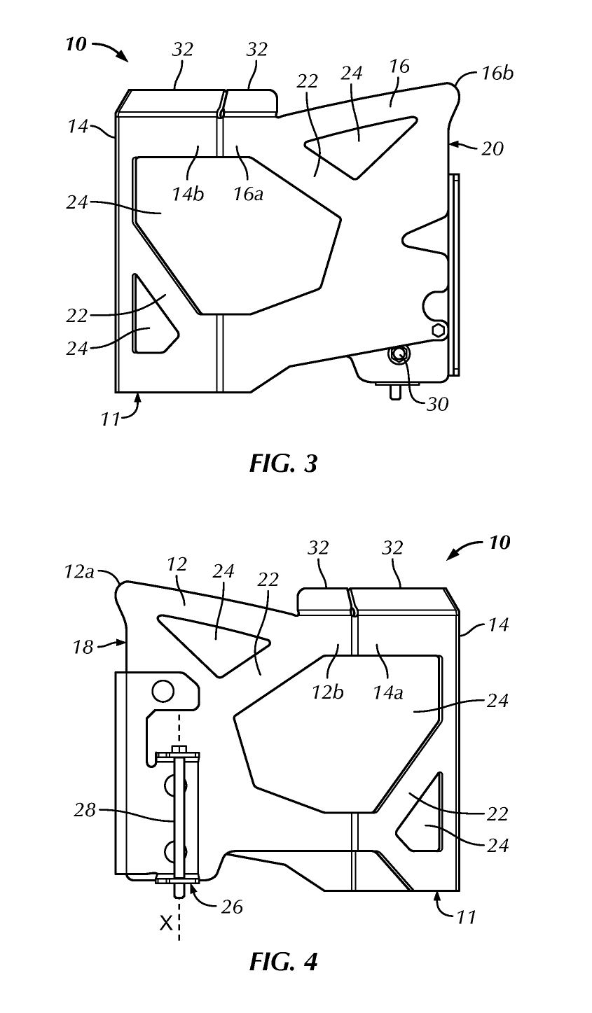

Referring to FIGS. 1-8, a rotatable engine guard according to an embodiment of the present invention, herein referred to as the “guard” and generally designated 10, is shown. The guard 10 is attached to a ZT vehicle 100, and more particularly a ZT lawnmower 100. The ZT lawnmower 100 comprises a frame 102, an engine 104 supported on the frame 102 and configured to output rotational power, and two or more driving wheels 106 rotatably mounted to an underside of the frame 102.

The guard 10 comprises a body 11, preferably formed of a first segment 12, a second segment 14, and a third segment 16. In one embodiment, the first, second and third segments 12, 14, 16 are preferably fixedly attached together, such that the second segment 14 is securedly attached to the first segment 12, and the third segment 16 is securedly attached to the second segment 14 opposite the first segment 12. In another embodiment, the first, second and third segments 12, 14, 16 are preferably integrally formed with each other.

The first segment 12 has first and second ends 12a, 12b, the second segment 14 has first and second ends 14a, 14b, and the third segment 16 has first and second ends 16a, 16b. The first end 14a of the second segment 14 is attached to or integrally formed with the second end 12b of the first segment 12, and the first end 16a of the third segment 16 is attached to or integrally formed with the second end 14b of the second segment 14. The second end 16b of the third segment 16 is a free distal end.

Referring to FIG. 5, the guard 10 has a first end 18 extending in a first plane A and a second end 20 extending in a second plane B. The first and second planes A, B are spaced apart from each other and extend parallel to each other. The first segment 12 is disposed at the first end 18 and thus extends in the first plane A, while the third segment 16 is disposed at the second end 20 and thus extends in the second plane B. The second segment 14 extends in a third plane C which is generally orthogonal to the first and second planes A, B. More particularly, the second segment 14 extends between and perpendicular to the first and third segments 12, 16. As such, the body 11 formed by the plurality of segments 12, 14, 16 is generally U-shaped (see FIG. 5).

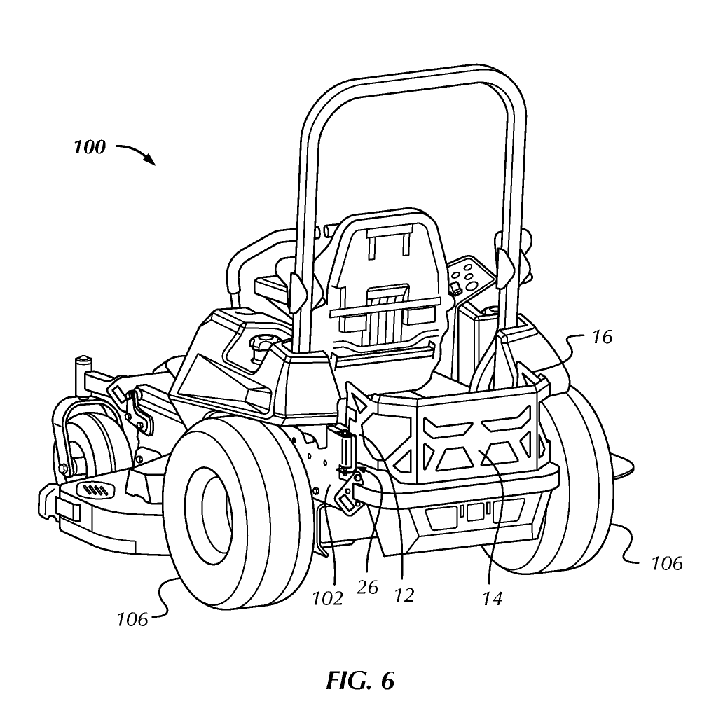

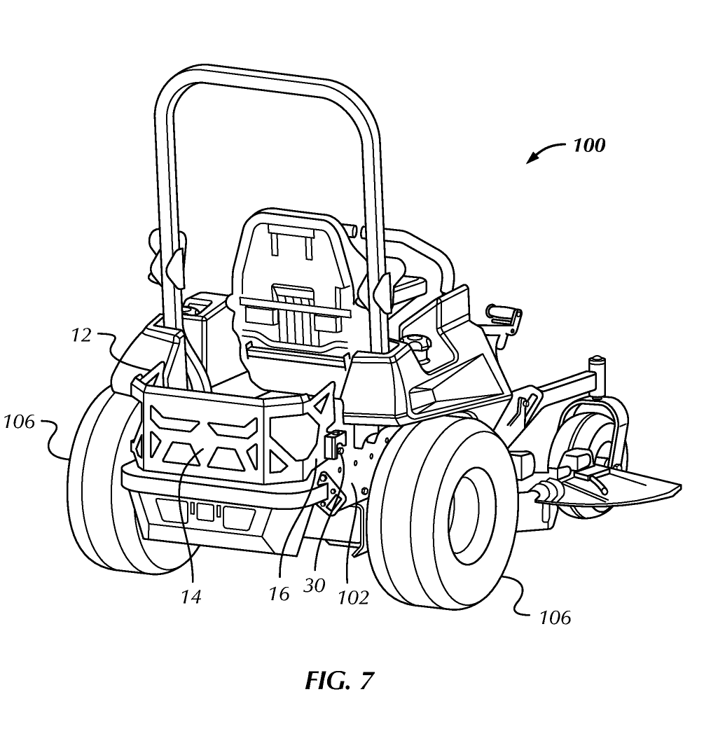

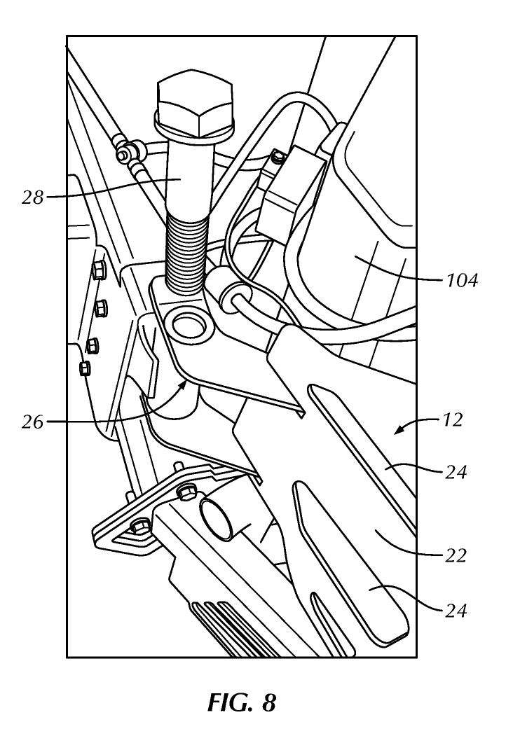

Referring to FIGS. 1-5, each of the segments 12, 14, 16 is preferably formed as a planar web 22 including a plurality of apertures or openings 24 formed therein. The apertures 24 are formed through the thickness of the segments 12, 14, 16. The apertures 24 may be formed in a random arrangement or in a predetermined arrangement designed to afford an optimum view of an engine 104 of a ZT vehicle 100 which is protected by the guard 10 (see FIGS. 6-7). By providing the plurality of apertures 24 connected by the planar web 22, the guard 10 has sufficient rigidity as needed to securely cover the engine 104 of the ZT vehicle 100, while also having a low weight and reduced material costs. The plurality of segments 12, 14, 16 are preferably made of a metallic material, but may be made of a polymeric, ceramic, wooden, or any other suitable material well known in the art.

Referring to FIGS. 1-2 and 4-5, the guard 10 also includes a hinge 26 fixedly attached to at least one of the first segment 12 and the third segment 16, and more particularly to one of the first end 12a of the first segment 12 and the second end 16b of the third segment 16. That is, the hinge 26 may be provided at either the first end 18 or the second end 20 of the guard 10, or alternatively, both ends 18, 20 of the guard 10 may include a hinge 26 fixedly attached thereto.

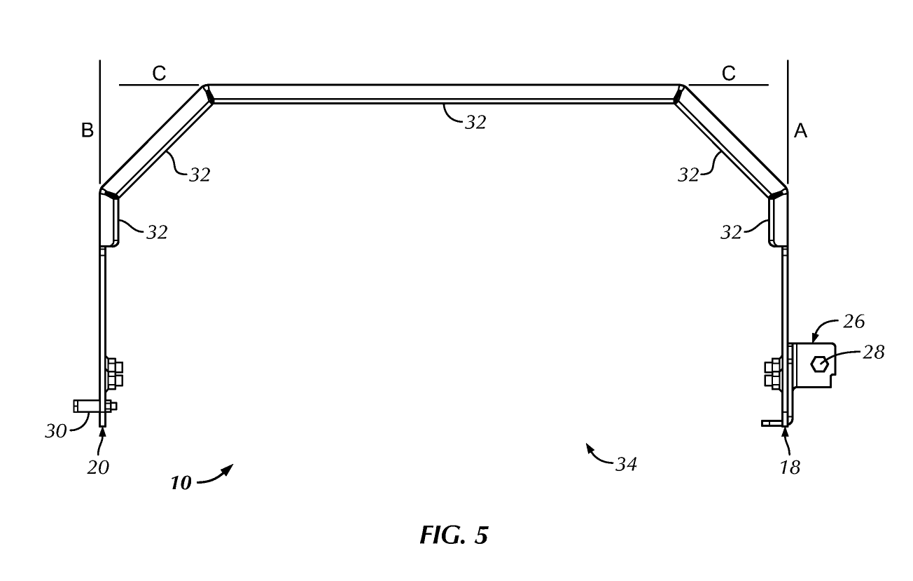

The hinge 26 includes a hinge pin 28 which is configured to engage a corresponding feature (not shown) on a frame 102 of a ZT vehicle 100, and more particularly a ZT lawnmower 100 (see FIGS. 6-7). The hinge pin 28 defines an axis X about which the guard 10 is capable of being pivoted or rotated relative to the ZT lawnmower 100. In a preferred embodiment, the hinge 26 and hinge pin 28 are oriented vertically relative to the ground surface (not shown), such that the guard 10 rotates in a horizontal plane about a vertical axis X (see FIG. 4). In another preferred embodiment (not shown), the hinge 26 is oriented horizontally relative to ground surface, such that the guard 10 rotates in a vertical plane about a horizontal axis (not shown). The hinge 26 is preferably made of a metallic material, but may be made from any other suitable material well known in the art.

The guard 10 further includes a latching mechanism 30 fixedly secured to the other of the first segment 12 and the third segment 16, and more particularly to the other of the first end 12a of the first segment 12 and the second end 16b of the third segment 16. More particularly, the latching mechanism 30 may be provided at either the first end 18 or the second end 20 of the guard 10, or alternatively, both ends 18, 20 of the guard 10 may include a latching mechanism 30 fixedly attached thereto.

In a preferred embodiment, the latching mechanism 30 extends orthogonally away from the third segment 16 in a direction generally opposite the first segment 12. The latching mechanism 30 is configured to engage a corresponding feature (not shown) on the frame 102 of the ZT lawnmower 100 (see FIGS. 6-7). The latching mechanism 30 and the corresponding feature of the frame 102 of the ZT lawnmower 100 may be selectively engaged or disengaged by a user of the ZT lawnmower 100 to allow the guard 10 to be fully secured to the ZT lawnmower 100 or rotatable relative thereto. Specifically, in a first position, where the latching mechanism 30 is engaged or otherwise mated with the corresponding feature of the frame 102 of the ZT lawnmower 100, rotational movement of the guard 10 about the hinge pin 28 of the hinge 26 is prevented, such that the engine 104 of the ZT lawnmower 100 is covered by the guard 10 and inaccessible by the user. In a second position, where the latching mechanism 30 and the corresponding feature of the frame 102 are disengaged from each other, the guard 10 can be rotated relative to the ZT lawnmower 100 about the vertical axis X and hinge pin 28 of the hinge 26. In a preferred embodiment, the latching mechanism 30 and the corresponding feature on the frame 102 of the ZT lawnmower 100 form a bolt, gate-type latch which self-latches when the two elements interact. However, it will be understood that any other suitable type of latch which selectively engages two surfaces could be used without departing from the scope of the present invention. The latching mechanism 30 is preferably formed of a metallic material, but may be formed of any other suitable material well known in the art.

The guard 10 further includes at least one baffle 32, and more particularly a plurality of baffles 32, extending upwardly from a top end 11a of the body 11. More particularly, the baffles 32 extend at least partially along a top edge 12c, 14c, 16c of each of the plurality of segments 12, 14, 16. In a preferred embodiment, the baffles 32 extend at an angle from the top edges 12c, 14c, 16c of the segments 12, 14, 16 toward a center cavity 34 of the body 11 (see FIG. 5). The baffles 32 are preferably integrally formed with a corresponding one of the segments 12, 14, 16. The baffles 32 are also preferably formed of the same material as the corresponding one of the segments 12, 14, 16.

In operation, the guard 10 is attached to the ZT lawnmower 100 by the hinge 26, and the hinge pin 28 is inserted into the corresponding feature on the frame 102 of the ZT lawnmower 100 and is secured to the hinge 26. Once attached, the guard 10 can freely rotate about the hinge pin 28 relative to the frame 102 of the ZT lawnmower 100. Where the hinge 26 is provided at both ends 18, 20 of the guard 10, the guard 10 may be selectively rotated about either hinge 26.

In order to cover the engine 104 of the ZT lawnmower 100 by the guard 10, the guard 10 is rotated in a direction toward the ZT lawnmower 100, until the latching mechanism 30 of the guard 10 engages the corresponding feature on the frame 102 of the ZT lawnmower 100 to secure and prevent rotation of the guard 10. When in the latched state, the guard 10 serves to shield the engine 104 from contact with the environment or the user, thereby preventing engine damage. Simultaneously, the latched guard 10 prevents the user from contacting the engine and sustaining injury. When access to the engine 104 is needed, the user can disengage the latching mechanism 30 and rotate the guard 10 in a direction away from the frame 102 of the ZT lawnmower 100, so as to expose the engine 104 from the guard 10.

Alternatively, the user may remove the hinge pin 28 (or both hinge pins 28 were a hinge 26 is provided at both ends 18, 20), and entirely remove the guard 10 from the ZT lawnmower 100 for enabling accessing to the engine 104. When access to the engine 104 is no longer needed, the respective hinge pin(s) 28 is/are reinserted and the guard 10 is returned to the attached state.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1. A zero-turn (“ZT”) vehicle comprising:
a frame;
an engine supported on the frame and configured to output rotational power;
two or more driving wheels rotatably mounted to an underside of the frame; and
a guard having a first end and a second end, the first end being fixedly secured to the frame by a hinge mechanism, the second end being configured to engage the frame by a latching mechanism,
wherein, in a first position, the second end of the guard is engaged with the frame by the latching mechanism, such that the engine is covered by the guard; and
wherein, in a second position, the second end of the guard is disengaged from the frame by the latching mechanism, such that the guard is rotatable about the hinge mechanism so as to expose the engine from the guard.

2. The ZT vehicle according to claim 1, wherein the hinge mechanism is vertically oriented.

3. The ZT vehicle according to claim 1,
wherein the guard comprises a U-shaped body formed of a first segment, a second segment and a third segment, each segment having a first end and an opposing second end, and
wherein the hinge mechanism is fixedly secured to the first end of the first segment and the latching mechanism is secured to the second end of the third segment.

4. The ZT vehicle according to claim 3, wherein the first and third segments extend parallel to each other in spaced apart planes, and wherein the second segment extends between and perpendicular to the first and third segments.

5. The ZT vehicle according to claim 3, wherein each of the first, second and third segments is formed as a planar web including a plurality of apertures.

6. The ZT vehicle according to claim 1, wherein the second end of the first segment is attached to or integrally formed with the first end of the second segment, and wherein the second end of the second segment is attached to or integrally formed with the first end of the third segment, the second end of the third segment being a free distal end.

7. The ZT vehicle according to claim 1, wherein the ZT vehicle is a ZT lawnmower.

8. The ZT vehicle according to claim 1,
wherein the hinge mechanism includes a hinge pin, and
wherein, in a third position, the hinge pin is removed from the hinge mechanism, such that the guard may be completely disengaged from the frame.

9. A zero-turn (“ZT”) vehicle comprising:
a frame;
an engine supported on the frame and configured to output rotational power; and
a guard having a first end and a second end, at least one of the first and second ends being fixedly secured to the frame by a hinge mechanism,
wherein, in a first position, the first and second ends of the guard engage the frame, such that the engine is covered by the guard; and
wherein, in a second position, at least one of the first and second ends of the guard is disengaged from the frame, such that the guard is rotatable about the hinge mechanism so as to expose the engine from the guard.
